(19) United States
(12) Patent Application Publication
(10) Pub. No.: US 2008/0220793 A1
(43) Pub. Date: Sep. 11, 2008

(54) Apparatus and method for allocating resource in wireless communication system

(75) Inventors: Jae-Woo So, Bucheon-si (KR); June Moon, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/074,987

(22) Filed: Mar. 6, 2008

(30) Foreign Application Priority Data
Mar. 6, 2007 (KR) 2007-0021813

(51) Int. Cl. H04Q 7/22

(52) U.S. Cl. 455/452.2

(57) ABSTRACT

Provided is an apparatus and method for allocating resources in a wireless communication system. In method, whether there are one or more mobile stations periodically transmitting or receiving data of the same size, among mobile station to be provided with a service is determined if a predetermined region of a frame is set as a fixed region to be allocated to mobile stations that periodically transmit or receive data of the same size. The channel states of the mobile stations are detected if there are mobile stations periodically transmitting or receiving data of the same size. Resources of the fixed region are allocated according to the channel states of the mobile stations. The resource allocation information is transmitted to the mobile stations.

### CROSS-REFERENCE TO RELATED APPLICATION(S) AND CLAIM OF PRIORITY

This application claims priority under 35 U.S.C. §119(a) to an application filed in the Korean Intellectual Property Office on Mar. 6, 2007 and assigned Serial No. 2007-21813, the contents of which are incorporated herein by reference.

### TECHNICAL FIELD OF THE INVENTION

The present invention relates generally to an apparatus and method for allocating resources in a wireless communication system, and in particular, to an apparatus and method for allocating resources in a wireless communication system in order to transmit fixed-length data.

### BACKGROUND OF THE INVENTION

The rapid growth of mobile communication markets necessitates providing various multimedia services in wireless environments. What is thus required is a technology to transmit large-capacity data at a high data rate in wireless communication systems in order to provide various multimedia services. Furthermore, research is being conducted on a wireless communication system that can provide high Quality of Service (QoS) and high mobility.

The Institute of Electrical and Electronics Engineers (IEEE) 802.16 Working Group is standardizing wireless communication technologies to provide high-rate data transmission using an Orthogonal Frequency Division Multiplexing (OFDM) or Orthogonal Frequency Division Multiple Access (OFDMA) scheme.

An OFDM/OFDMA wireless communication system defined in the IEEE 802.16 standard performs communication using a frame structure constructed as illustrated in FIG. 1.

FIG. 1 is a diagram illustrating a frame structure of a conventional wireless communication system.

Referring to FIG. 1, a frame 100 includes a downlink (DL) subframe 110 and an uplink (UL) subframe 120.

The DL subframe 110 includes a sync channel region, a control channel region, and a burst region.

The sync channel region includes a preamble that mobile stations within the coverage area of a base station (BS) use to acquire time/frequency synchronization.

The control channel region includes MAP information and a frame control header including information for decoding frame MAP. Herein, the MAP includes a DL MAP including resource allocation information for bursts of the DL subframe 110 and a UL MAP including resource allocation information for bursts of the UL subframe 120.

The burst region includes regions to which data, which are to be transmitted to mobile stations serviced by a BS, are allocated according to the DL MAP information.

The UL subframe 120 includes a control channel region and a burst region.

The control channel region of the UL subframe 120 is used to transmit a control channel (e.g., a sounding channel or a ranging channel) that is transmitted from mobile stations to a BS.

The burst region of the UL subframe 120 includes regions to which data, which are to be transmitted from mobile stations serviced by a BS to the BS, are allocated according to the UL MAP information.

As described above, a BS of the wireless communication system transmits a MAP, including resource allocation information of mobile stations serviced by the BS, to the mobile stations at every frame. For example, the BS constructs a DL MAP, including DL resource allocation information of mobile stations serviced by the BS, at every frame.

Also, the BS constructs a UL MAP, including UL resource allocation information of mobile stations serviced by the BS, at every frame.

The frame, which is constructed as illustrated in FIG. 1 to perform communication in the wireless communication system, has a fixed size. Thus, the size of a burst to which data is allocated decreases with an increase in the MAP including the resource allocation information of the mobile stations, which causes the MAP to operate as an overhead in the wireless communication system. Moreover, the amount of resource allocation information to be included in the MAP increases with an increase in the number of the mobile stations serviced, which increases a transmission overhead in the wireless communication system.

### SUMMARY OF THE INVENTION

To address the above-discussed deficiencies of the prior art, it is a primary object of the present invention to substantially solve at least the above problems and/or disadvantages and to provide at least the advantages below. Accordingly, an object of the present invention is to provide an apparatus and method for reducing a transmission overhead in a wireless communication system.

Another object of the present invention is to provide an apparatus and method for reducing the amount of resource allocation information in a wireless communication system.

Still another object of the present invention is to provide an apparatus and method for reducing the amount of resource allocation information for a mobile station (MS) that periodically transmits/receives data of the same size in a wireless communication system.

Even another object of the present invention is to provide an apparatus and method for reducing the amount of DL resource allocation information for a mobile station (MS) that periodically receives data of the same size in a wireless communication system.

Yet another object of the present invention is to provide an apparatus and method for reducing the amount of UL resource allocation information for a mobile station (MS) that periodically transmits data of the same size in a wireless communication system.

According to one aspect of the present invention, a method for allocating resources in a wireless communication system includes: determining whether there are one or more mobile stations periodically transmitting/receiving data of the same size, among mobile station to be provided with a service, if a predetermined region of a frame is set as a fixed region to be allocated to mobile stations that periodically transmit/receive data of the same size; detecting the channel states of the mobile stations if there are mobile stations periodically transmitting/receiving data of the same size; allocating resources of the fixed region according to the channel states of the mobile stations; and transmitting the resource allocation information to the mobile stations.

According to another aspect of the present invention, a method for detecting allocated resources in a wireless communication system includes: if a predetermined region of a frame is set as a fixed region to be allocated to mobile stations that periodically transmit/receive data of the same size; obtaining information of the fixed region from a transmitter; and detecting resources of the fixed region, allocated from the transmitter, from resource allocation information received from the transmitter, if data of the same size are transmitted/received periodically.

According to still another aspect of the present invention, an apparatus for allocating resources in a wireless communication system includes: a scheduler for allocating, if a predetermined region of a frame is set as a fixed region to be allocated to mobile stations that periodically transmits/receives data of the same size, resources of the fixed region to the mobile station that periodically transmits/receives data of the same size; a message generator for generating a message including information of the fixed region and generating a resource allocation message for the mobile station allocated to the fixed region by the scheduler; and a transmitter for transmitting the resource allocation message to the mobile stations.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a frame structure of a conventional wireless communication system;

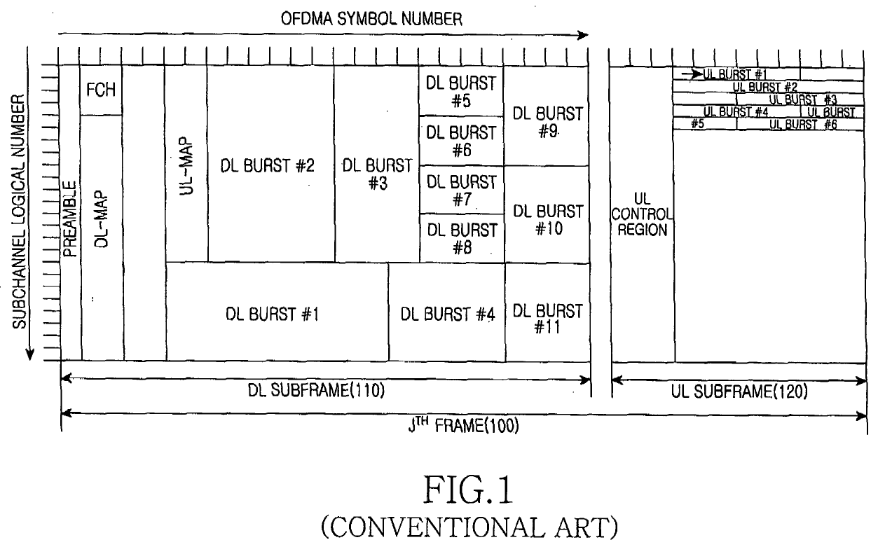

FIG. 2 is a diagram illustrating a frame structure of a wireless communication system according to an embodiment of the present invention;

FIG. 3 is a flowchart illustrating an operation of a base station (BS) for allocating DL resources in the wireless communication system according to an embodiment of the present invention;

FIG. 4 is a flowchart illustrating an operation of a mobile station (MS) for receiving DL signals in the wireless communication system according to an embodiment of the present invention;

FIG. 5 is a flowchart illustrating an operation of the base station (BS) for allocating UL resources in the wireless communication system according to an embodiment of the present invention;

FIG. 6 is a flowchart illustrating an operation of the mobile station (MS) for transmitting UL signals in the wireless communication system according to an embodiment of the present invention;

FIG. 7 is a block diagram of the base station (BS) in the wireless communication system according to the present invention; and

FIG. 8 is a block diagram of the mobile station (MS) in the wireless communication system according to the present invention.

### DETAILED DESCRIPTION OF THE INVENTION

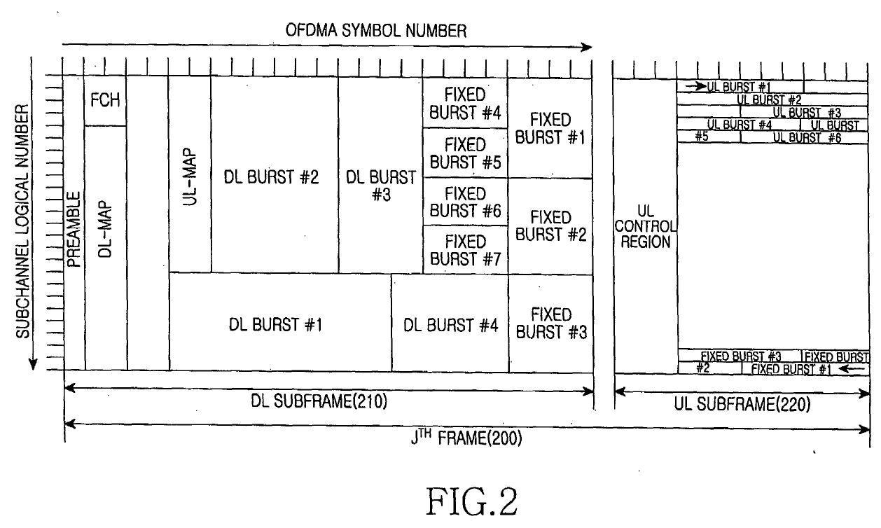

FIGS. 2 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention is intended to provide a scheme for reducing the amount of resource allocation information for mobile stations that periodically transmit/receive data of the same size in a wireless communication system.

The following description is made in the context of a Time Division Duplex-Orthogonal Frequency Division Multiple Access (TDD-OFDMA) wireless communication system, to which the present invention is not limited. Thus, it is to be clearly understood that the present invention is applicable to any other multiple access scheme.

In the following description, data of the same size transmitted/received periodically in the wireless communication system is referred to as fixed-length data. For example, when the wireless communication system provides a Voice over Internet Protocol (VoIP) service, base stations and mobile stations transmit and receive fixed-length data.

The wireless communication system may construct a frame that includes a separate burst region for allocation of fixed-length data as illustrated in FIG. 2.

FIG. 2 is a diagram illustrating a frame structure of a wireless communication system according to an embodiment of the present invention.

Referring to FIG. 2, a frame 200 includes a downlink (DL) subframe 210 and an uplink (UL) subframe 220.

The DL subframe 210 includes a sync channel region, a control channel region, and a burst region.

The sync channel region includes a preamble for providing time/frequency synchronization for mobile stations.

The control channel region includes a frame control header and MAP information. The frame control header includes information for decoding the MAP. The MAP includes resource allocation information of mobile stations allocated to the burst region. For example, the MAP includes a DL MAP including resource allocation information for bursts of the DL subframe 210 and a UL MAP including resource allocation information for bursts of the UL subframe 220.

The burst region includes regions to which data, which are to be transmitted to mobile stations serviced by a base station (BS), are allocated according to the DL MAP information. For example, the burst region is divided into a fixed region for allocation of fixed-length data and a nonfixed region for allocation of nonfixed-length data. Herein, the size of the fixed region may vary depending on the number of mobile stations using fixed-length data and the size of fixed-length data.

The UL subframe 220 includes a control channel region and a burst region.

The control channel region of the UL subframe 220 is used to transmit a control channel (e.g., a sounding channel or a ranging channel) that is transmitted from mobile stations to a BS.

The burst region of the UL subframe 220 includes regions to which data, which are to be transmitted from mobile stations serviced by a BS to the BS, are allocated according to the UL MAP information. For example, the burst region of the UL subframe 220 is divided into a fixed region for allocation of fixed-length data and a nonfixed region for allocation of nonfixed-length data. Herein, the size of the fixed region may vary depending on the number of mobile stations using fixed-length data and the size of fixed-length data.

As described above, the wireless communication system constructs a frame by allocating a separate burst region for fixed-length data. For example, depending on Modulation and Coding Scheme (MCS) levels, the wireless communication system allocates different-sized resources to the separate burst region for the fixed-length data. Herein, the size of the resource allocated according to the MCS level represents the number of slots allocated according to the MCS level.

In the following description, the separate burst region for the fixed-length data is referred to a fixed region.

When the wireless communication system constructs a frame including the fixed region illustrated in FIG. 2, mobile stations must detect information about the fixed region before there are allocated resources. Thus, the BS provides information about the start point of the fixed region and the allocated resource sizes depending on the MCS levels to the mobile stations before it allocates resources to the mobile stations. For example, the BS provides the information about the start point of the fixed region and the allocated resource sizes depending on the MCS levels to the mobile stations by means of a Downlink Channel Description (DCD)/Uplink Channel Description (UCD) message.

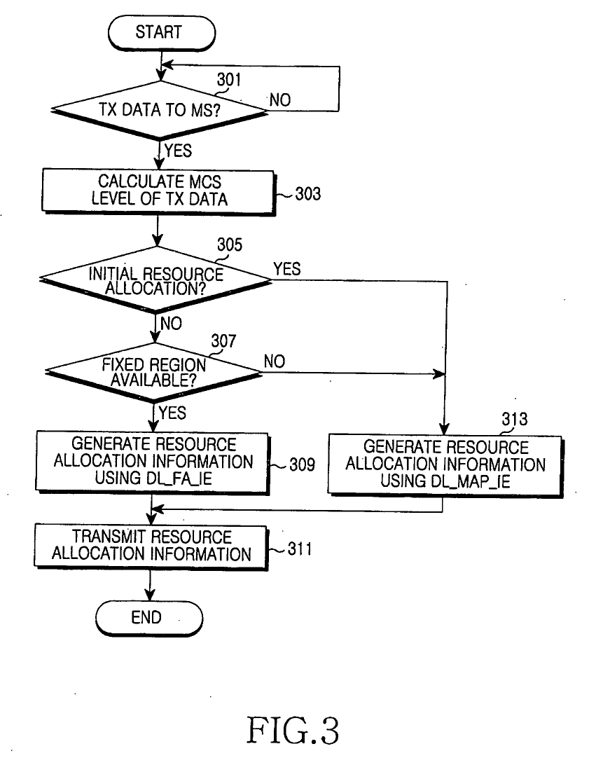

When the wireless communication system constructs a frame including the fixed region illustrated in FIG. 2, the BS operates as illustrated in FIG. 3 in order to allocate DL region resources to mobile stations serviced by the BS.

FIG. 3 is a flowchart illustrating an operation of the base station (BS) for allocating DL resources in the wireless communication system according to an embodiment of the present invention.

Referring to FIG. 3, in step 301, the BS determines whether there are data to be transmitted to mobile stations within the coverage area of the BS.

If there are data to be transmitted to the mobile stations, the operation proceeds to step 303. In step 303, the BS detects the MCS level depending on channel information for the mobile stations to receive the data. At this point, the BS also detects the number of repetitions of a repetition code and a Downlink Interval Usage Code (DIUC) depending on the channel information for the mobile stations.

In step 305, the BS determines whether there is a mobile station (MS) to be initially allocated radio resources among the mobile stations to receive the data.

If there is a mobile station (MS) to be initially allocated radio resources, the operation proceeds to step 313. In step 313, the BS determines a DL radio resource region to be allocated to the MS, in consideration of the MCS level and the length of data to be transmitted to the MS. At this point, the BS determines a burst region to be allocated to the MS in a DL burst by checking if the MS performs communication using fixed-length data. For example, when the MS performs communication using fixed-length data, the BS determines that the resource of a fixed region is allocated to the MS. At this point, the BS allocates a fixed region identifier (ID), a fixed region allocation period, and a fixed region usage count to the MS.

After determination of the radio resource region to be initially allocated to the MS, the BS generates a resource allocation message including information about the radio resource region to be initially allocated to the MS. For example, the BS generates a resource allocation message constructed as shown in Table 1.

TABLE 1

| Syntax | Size | Notes |
|---|---|---|
| DIUC | 4 bits | |
| if (INC_CID==1){ | | |
| N_CID | 8 bits | |
| for (n=0; n<N_CID; n++){ | | |
| CID | 16 bits | |
| } | | |
| } | | |
| Fixed Allocation Indicator | 2 bits | An indicator indicating that the next resource allocation is |
| | | performed in a Fixed Allocation scheme |
| | | 0: Not a Fixed Allocation scheme |
| | | 1: Perform resource allocation in a Fixed Allocation |
| | | scheme |
| | | 2: Release resources allocated in a Fixed Allocation |
| | | scheme |
| if (Fixed Allocation Indicator==1){ | | |
| FA_ID | 6 bits | An identifier identifying an MS in a Fixed Allocation |
| | | region |
| FA_Period | 2 bits | A Fixed Allocation period = 2\hat{ }p (0: Allocation per frame) |
| FA_Count | 4 bits | Fixed Allocation count = 2\hat{ }c (0xF: Continuous |
| | | allocation) |
| } | | |
| OFDMA symbol offset | 8 bits | |
| Subchannel offset | 6 bits | |
| Boosting | 3 bits | |
| No. OFDMA symbols | 7 bits | |
| No. subchannels | 6 bits | |
| Repetition coding indication | 2 bits | 0b00 No repetition coding |
| | | 0b01 Repetition coding of 2 used |
| | | 0b10 Repetition coding of 4 used |
| | | 0b11 Repetition coding of 6 used |

As shown in Table 1, the resource allocation message (DL_MAP_IE) includes: information about a DIUC indicating a physical channel processing scheme (e.g., a modulation scheme and a coding scheme) for a DL data burst to be transmitted; information about a connection ID (CID) identifying an MS to receive the resource allocation message; information about a fixed region allocation indicator (Fixed Allocation Indicator) indicating the use of the resources of a fixed region; information about a fixed region ID (FA_ID) identifying an MS for use of the fixed region; information about a fixed region period (FA_Period) indicating the usage period of the fixed region; information about a fixed region count (FA_Count) indicating the usage count of the fixed region; information about an OFDM symbol offset indicating the start point of an OFDM symbol for a data burst to be allocated; information about a subchannel offset indicating a start index number of a subchannel transmitting a data burst; information about the number of OFDM symbols (No. OFDM symbols) indicating the number of OFDM symbols occupied by a data burst to be transmitted, information about the number of subchannels (No. subchannels) indicating the number of subchannels transmitting a data burst; and information about a repetition coding indication indicating whether repetition coding has been performed on an information code of a data burst to be transmitted.

As shown in Table 1, using the fixed region allocation indicator, BS indicates whether to allocate the fixed region resources to the MS. If fixed region resources are allocated to the MS, the BS allocates a fixed region identifier (ID), a fixed region allocation period, and a fixed region usage count to the MS.

Also, if fixed region resources are allocated to an MS to be initially allocated radio resources, the BS indicates the size of a fixed region to be allocated to the MS, by using the OFDM symbol offset information, the subchannel offset information, the information about the number of OFDM symbols, and the information about the number of subchannels.

If the MS is not allocated the fixed region resources, the BS allocates a nonfixed region of a DL burst region to the MS by using the OFDM symbol offset information, the subchannel offset information, the information about the number of OFDM symbols, and the information about the number of subchannels.

On the other hand, if there is no MS to be initially allocated radio resources among the mobile stations to receive the data (in step 305), the operation proceeds to step 307. In step 307, the BS determines whether there is an MS performing communication using fixed-length data among the mobile stations. That is, the BS determines whether there is an MS to be allocated the resources of a fixed region among the mobile stations.

If there is an MS to be allocated the fixed region resources, the operation proceeds to step 309. Instep 309, according to the MCS level depending on channel information for the MS, the BS determines the fixed region resources to be allocated to the MS.

After determination of the fixed region resources to be allocated to the MS, the BS generates a resource allocation message including allocation information about the fixed region resources. For example, the BS generates a resource allocation message constructed as shown in Table 2.

TABLE 2

| Syntax | Size | Notes |
|---|---|---|
| DIUC | 4 bits | |
| Extended DIUC | 4 bits | Use a reserved field of IEEE 802.16e (e.g., 0xC) |
| Length | 8 bits | Length in bytes of the following fields |
| Num_Region | 2 bits | Number of FA regions |
| for (i=0; i<Num_Region; i++){ | | |
| MCS level | 2 bits | 0: QPSK ½ with two Repetition |
| | | 1: QPSK ½ without Repetition |
| | | 2: QPSK ¾ without Repetition |
| | | 3: 16QAM ½ without Repetition |
| Num_FA | 6 bits | This field indicates the number of the FA connections |
| for (j=0; j<Num_FA; j++){ | | |
| FA_ID | 6 bits | Index to uniquely identify the FA resource assigned to the MS |
| } | | |
| } | | |
| Padding | variable | Number of bits required to align to byte length, shall be set zero |

As shown in Table 2, the resource allocation message (DL_FA_IE) includes: information about a DIUC indicating a physical channel processing scheme (e.g., a modulation scheme and a coding scheme) for a DL data burst to be transmitted; information about a length (Length) indicating the length of the resource allocation message; information about an MCS level index (MCS level) indicating the MSC level of TX data; information about the number of fixed regions (Num_FA) indicating the number of mobile stations using the same MCS level; and information about a fixed region ID (FA_ID) identifying an MS to receiver the resource allocation message. Herein, the fixed region ID indicates a fixed region ID that is allocated from the BS when the mobile stations to be allocated the fixed region resources are initially allocated radio resources as shown in Table 1.

As shown in Table 2, depending on the level of an MS, the BS determines the resource size of a fixed region to be allocated to the MS. For example, if the MCS level index is ‘0’ according to the level of an MS, the BS allocates 16 slots to the MS. On the other hand, if the MCS level index is ‘1’, the BS allocates 8 slots to the MS. Herein, the slot is a basic unit for allocation of resources by the BS, and (2 symbols)×(1 subchannel) is used as one slot in case of a Partial Usage of Subchannel (PUCS) region of the DL subframe.

Furthermore, if a plurality of mobile stations are to be allocated fixed region resources, the BS may transmit resource allocation information to the mobile stations by using a single resource allocation message constructed as shown in Table 2. That is, the BS may transmit resource allocation information to a plurality of mobile stations by using a single resource allocation message without generating a resource allocation message for each MS. For example, assuming that an MS A, an MS B, an MS C and an MS D, which are respectively allocated a fixed region ID 1, a fixed region ID 2, a fixed region ID 3 and a fixed region ID 4, are located in the coverage area of the BS. In this case, based on Table 2, the BS generates a resource allocation message according to Table 3 in order to transmit data to the mobile stations A, B, C and D. Herein, it is assumed that the MCS level indexes of the mobile stations A and D are ‘0’ and the MCS level index of the MS B is ‘1’.

TABLE 3

| Syntax | Value | Length |
|---|---|---|
| DIUC | 14 | 4 bits |
| Extended DIUC | 0XC | 4 bits |
| Length | 5 | 8 bits |
| Num_Region | 2 | 2 bits |
| MCS level | 0 | 2 bits |
| Num_FA | 2 | 6 bits |
| FA_ID | 1 | 6 bits |
| FA_ID | 4 | 6 bits |
| MCS level | 1 | 2 bits |
| Num_FA | 1 | 6 bits |
| FA_ID | 2 | 6 bits |

As shown in Table 3, the resource allocation message indicates region information allocated to the respective mobile stations with the same MCS level. For example, the BS allocates 16 slots to each of the mobile stations A and D with an MCS level index of ‘0’ and then allocates 8 slots to the MS B with an MCS level index of ‘1’.

Thus, the BS generates a resource allocation message constructed as shown in Table 3 in order to indicate the region information allocated to the respective mobile stations with the same MCS level.

On the other hand, if there is no MS to be allocated the fixed region resources (in step 307), the operation proceeds to step 313. In step 313, the BS determines a resource region to be allocated to the MS, in consideration of the MCS level and the data to be transmitted to the MS. Herein, the BS determines the resource region to be allocated to the MS, in the DL burst region except the fixed region.

After determination of the resource region to be allocated to the MS, the BS generates a resource allocation message including the resource allocation region information. For example, the BS may generate a resource allocation message where a fixed region allocation indicator is set to ‘0’ in Table 1. In another embodiment, the BS may generate a resource allocation message defined in the IEEE 802.16 standard as shown in Table 4.

TABLE 4

| Syntax | Size | Notes |
|---|---|---|
| DIUC | 4 bits | |
| if (INC_CID==1){ | | |
| N_CID | 8 bits | |
| for (n=0; n<N_CID; n++){ | | |
| CID | 16 bits | |
| } | | |
| } | | |
| OFDMA symbol offset | 8 bits | |
| Subchannel offset | 6 bits | |
| Boosting | 3 bits | |
| No. OFDMA symbols | 7 bits | |
| No. subchannels | 6 bits | |
| Repetition coding indication | 2 bits | 0b00 No repetition coding |
| | | 0b01 Repetition coding of 2 |
| | | used |
| | | 0b10 Repetition coding of |
| | | 4 used |
| | | 0b11 Repetition coding of |
| | | 6 used |

As shown in Table 4, the resource allocation message (DL_MAP_IE) includes: information about a DIUC indicating a physical channel processing scheme (e.g., a modulation scheme and a coding scheme) for a DL data burst to be transmitted; information about a connection ID (CID) identifying an MS to receive the resource allocation message; information about an OFDM symbol offset indicating the start point of an OFDM symbol for a data burst to be allocated; information about a subchannel offset indicating a start index number of a subchannel transmitting a data burst; information about the number of OFDM symbols (No. OFDM symbols) indicating the number of OFDM symbols occupied by a data burst to be transmitted, information about the number of subchannels (No. subchannels) indicating the number of subchannels transmitting a data burst; and information about a repetition coding indication indicating whether repetition coding has been performed on an information code of a data burst to be transmitted.

After generation of the resource allocation message in step 309 or 313, the BS transmits the generated resource allocation message to the mobile stations in step 311.

Thereafter, the operation is ended.

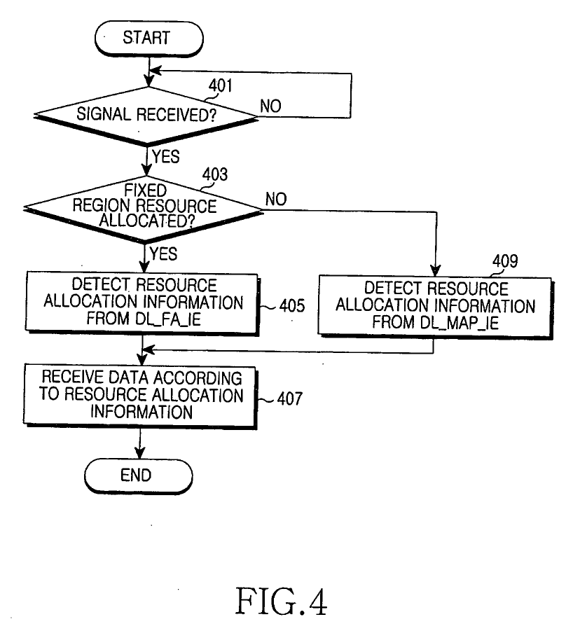

When the BS of the wireless communication system allocates radio resources as illustrated in FIG. 3, the MS operates as illustrated in FIG. 4 in order to detect the radio resources.

FIG. 4 is a flowchart illustrating an operation of the mobile station (MS) for receiving DL signals in the wireless communication system according to an embodiment of the present invention.

Referring to FIG. 4, in step 401, the MS determines if a signal is received from the BS.

If a signal received from the BS, the operation proceeds to step 403. In step 403, the MS determines if the MS itself is allocated the fixed region resources, based on the resource allocation message included in the received signal. For example, the MS determines if the MS is allocated the fixed region resources, by detecting the fixed region allocation indicator in the resource allocation message constructed as shown in Table 1.

If the MS is allocated the fixed region resources, the operation proceeds to step 405. In step 405, the MS detects the fixed region resource allocation information from the resource allocation message constructed as shown in Table 1 or 2. For example, if the MS is initially allocated radio resources, the MS detects the fixed region resource allocation information from the resource allocation message constructed as shown in Table 1. At this point, the MS is allocated a fixed region ID through an initial resource allocation message constructed as shown in Table 1. Thus, if the MS is not initially allocated radio resources, the MS can detect the fixed region resource allocation information from the resource allocation message constructed as shown in Table 2. At this point, the MS can detect the start information of the fixed region and the allocated resource size information depending on the MCS level before receipt of the resource allocation message. Thus, the MS can detect the resources allocated to itself in the fixed region on the basis of the number of mobile stations having the same MCS level index as its own MCS level index shown in Table 2.

On the other hand, if the MS is not allocated the fixed region resources (in step 403), the operation proceeds to step 409. In step 409, the MS detects the resource allocation information from the resource allocation message constructed as shown in Table 1 or 4.

After detection of the resource allocation information, the MS receives data from the BS according to the resource allocation information in step 407.

Thereafter, the operation is ended.

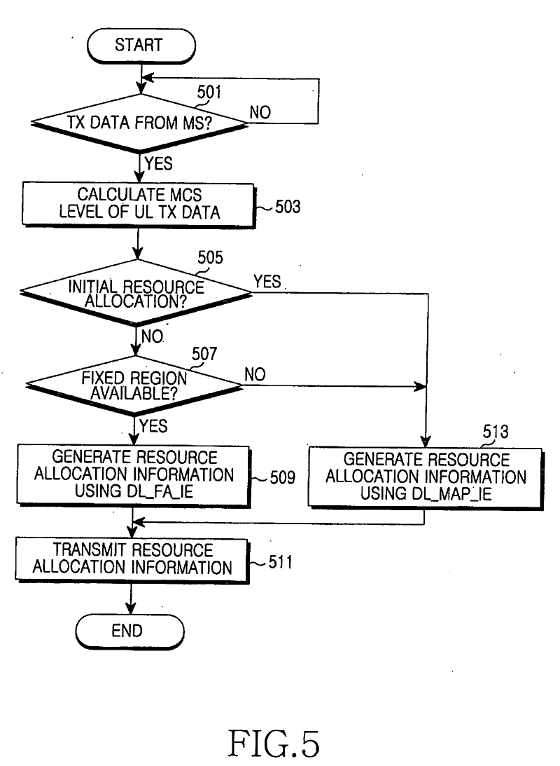

When the wireless communication system constructs a frame including the fixed region illustrated in FIG. 2, the BS operates as illustrated in FIG. 5 in order to allocate UL region resources to mobile stations serviced by the BS.

FIG. 5 is a flowchart illustrating an operation of the BS for allocating UL resources in the wireless communication system according to an embodiment of the present invention.

Referring to FIG. 5, in step 501, the BS determines whether there are data to be transmitted from mobile stations within the coverage area to the BS.

If there are data to be transmitted from the mobile stations to the BS, the operation proceeds to step 503. In step 503, the BS detects the MCS level depending on channel information for the mobile stations. At this point, the BS also detects the number of repetitions of a repetition code and a Uplink Interval Usage Code (UIUC) depending on the channel information for the mobile stations.

In step 505, the BS determines whether there is an MS to be initially allocated radio resources among the mobile stations.

If there is an MS to be initially allocated radio resources, the operation proceeds to step 513. In step 313, the BS determines a UL radio resource region to be allocated to the MS, in consideration of the MCS level and the length of the data to be transmitted from the MS. At this point, the BS determines a burst region to be allocated to the MS in a UL burst by checking if the MS performs communication using fixed-length data. For example, when the MS performs communication using fixed-length data, the BS determines that the resource of a fixed region is allocated to the MS. At this point, the BS allocates a fixed region identifier (ID), a fixed region allocation period, and a fixed region usage count to the MS.

After determination of the radio resource region to be initially allocated to the MS, the BS generates a resource allocation message including information about the radio resource region to be initially allocated to the MS. For example, the BS generates a resource allocation message constructed as shown in Table 5.

TABLE 5

| Syntax | Size | Notes |
|---|---|---|
| CID | 16 bits | |
| UIUC | 4 bits | |
| Fixed Allocation Indicator | 2 bits | An indicator indicating that the next resource allocation is performed |
| | | in a Fixed Allocation scheme |
| | | 0: Not a Fixed Allocation scheme |
| | | 1: Perform resource allocation in a Fixed Allocation scheme |
| | | 2: Release resources allocated in a Fixed Allocation scheme |
| if (Fixed Allocation | | |
| Indicator==1){ | | |
| FA_ID | 6 bits | An identifier identifying an MS in a Fixed Allocation region |
| FA_Period | 2 bits | A Fixed Allocation period = 2\hat{ }p (0: Allocation per frame) |
| FA_Count | 4 bits | Fixed Allocation count = 2\hat{ }c (0xF: Continuous allocation) |
| } | | |
| Duration | 10 bits | |
| Repetition Coding Indication | 2 bits | 0b00 No repetition coding |
| | | 0b01 Repetition coding of 2 used |
| | | 0b10 Repetition coding of 4 used |
| | | 0b11 Repetition coding of 6 used |

As shown in Table 5, the resource allocation message (UL_MAP_IE) includes: information about a connection ID (CID) identifying an MS to receive the resource allocation message; information about a UIUC indicating a physical channel processing scheme (e.g., a modulation scheme and a coding scheme) for a UL data burst to be transmitted; information about a fixed region allocation indicator (Fixed Allocation Indicator) indicating the use of the resources of a fixed region; information about a fixed region ID (FA_ID) identifying an MS for use of the fixed region; information about a fixed region period (FA_Period) indicating the usage period of the fixed region; information about a fixed region count (FA_Count) indicating the usage count of the fixed region; information about the duration indicating the size of a data burst in a UL burst through the resource allocation message; and information about a repetition coding indication indicating whether repetition coding has been performed on an information code of a data burst to be transmitted.

As shown in Table 5, using the fixed region allocation indicator, BS indicates whether to allocate the fixed region resources to the MS. If fixed region resources are allocated to the MS, the BS allocates a fixed region identifier (ID), a fixed region allocation period, and a fixed region usage count to the MS.

Also, if fixed region resources are allocated to an MS to be initially allocated radio resources, the BS indicates the size of a fixed region to be allocated to the MS, by using the duration information.

If the MS is not allocated the fixed region resources, the BS allocates a nonfixed region of a UL burst region to the MS by using the duration information.

On the other hand, if there is no MS to be initially allocated radio resources among the mobile stations (in step 505), the operation proceeds to step 507. In step 507, the BS determines whether there is an MS performing communication using fixed-length data among the mobile stations. That is, the BS determines whether there is an MS to be allocated the resources of a fixed region among the mobile stations.

If there is an MS to be allocated the fixed region resources, the operation proceeds to step 509. Instep 509, according to the MCS level depending on channel information for the MS, the BS determines the fixed region resources to be allocated to the MS.

After determination of the fixed region resources to be allocated to the MS, the BS generates a resource allocation message including allocation information about the fixed region resources. For example, the BS generates a resource allocation message constructed as shown in Table 6.

TABLE 6

| Syntax | Size | Notes |
|---|---|---|
| UIUC | 4 bits | |
| Extended UIUC | 4 bits | Use a reserved field of IEEE 802.16e (e.g., 0xC) |
| Length | 8 bits | Length in bytes of the following fields |
| Num_Region | 2 bits | Number of FA regions |
| for (i =0; i<Num_Region; i++){ | | |
| MCS level | 2 bits | 0: QPSK ½ with two Repetition |
| | | 1: QPSK ½ without Repetition |
| | | 2: QPSK ¾ without Repetition |
| | | 3: 16QAM ½ without Repetition |
| Num_FA | 6 bits | This field indicates the number of the FA connections |
| for (j=0; j<Num_FA; j++){ | | |
| FA_ID | 6 bits | Index to uniquely identify the FA resource assigned to |
| | | the MS |
| } | | |
| } | | |
| padding | variable | Number of bits required to align to byte length, shall be |
| | | set zero |

As shown in Table 6, the resource allocation message (UL_FA_IE) includes: information about a UIUC indicating a physical channel processing scheme (e.g., a modulation scheme and a coding scheme) for a UL data burst to be transmitted; information about a length (Length) indicating the length of the resource allocation message; information about an MCS level index (MCS level) indicating the MSC level of TX data; information about the number of fixed regions (Num_FA) indicating the number of mobile stations using the same MCS level; and information about a fixed region ID (FA_ID) identifying an MS to receiver the resource allocation message. Herein, the fixed region ID indicates a fixed region ID that is allocated from the BS when the mobile stations to be allocated the fixed region resources are initially allocated radio resources as shown in Table 5.

As shown in Table 6, depending on the level of an MS, the BS determines the resource size of a fixed region to be allocated to the MS. For example, if the MCS level index is ‘0’ according to the level of an MS, the BS allocates 12 slots to the MS. On the other hand, if the MCS level index is ‘1’, the BS allocates 6 slots to the MS. Herein, the slot is a basic unit for allocation of resources by the BS, and (3 symbols)×(1 subchannel) is used as one slot in case of a Partial Usage of Subchannel (PUCS) region of the UL subframe.

Furthermore, if a plurality of mobile stations are to be allocated fixed region resources, the BS may transmit resource allocation information to the mobile stations by using a single resource allocation message constructed as shown in Table 6. That is, the BS may transmit resource allocation information to a plurality of mobile stations by using a single resource allocation message without generating a resource allocation message for each MS. For example, assuming that an MS A, an MS B, an MS C and an MS D, which are respectively allocated a fixed region ID 1, a fixed region ID 2, a fixed region ID 3 and a fixed region ID 4, are located in the coverage area of the BS. In this case, based on Table 6, the BS generates a resource allocation message according to Table 7 so that \ the mobile stations A, B, C and D can transmit data. Herein, it is assumed that the MCS level indexes of the mobile stations A and D are ‘0’ and the MCS level index of the MS C is ‘1’.

TABLE 7

| Syntax | Value | Length |
|---|---|---|
| UIUC | 11 | 4 bits |
| Extended UIUC | 0XC | 4 bits |
| Length | 5 | 8 bits |
| Num_Region | 2 | 2 bits |
| MCS level | 0 | 2 bits |
| Num_FA | 2 | 6 bits |
| FA_ID | 1 | 6 bits |
| FA_ID | 4 | 6 bits |
| MCS level | 1 | 2 bits |
| Num_FA | 1 | 6 bits |
| FA_ID | 3 | 6 bits |

As shown in Table 7, the resource allocation message indicates region information allocated to the respective mobile stations with the same MCS level. For example, the BS allocates 12 slots to each of the mobile stations A and D with an MCS level index of ‘0’ and then allocates 6 slots to the MS C with an MCS level index of ‘1’.

Thus, the BS generates a resource allocation message constructed as shown in Table 7 in order to indicate the region information allocated to the respective mobile stations with the same MCS level.

On the other hand, if there is no MS to be allocated the fixed region resources (in step 507), the operation proceeds to step 513. In step 513, the BS determines a resource region to be allocated to the MS, in consideration of the MCS level and the data to be transmitted from the MS. Herein, the BS determines the resource region to be allocated to the MS, in the UL burst region except the fixed region.

After determination of the resource region to be allocated to the MS, the BS generates a resource allocation message including the resource allocation region information. For example, the BS may generate a resource allocation message where a fixed region allocation indicator is set to ‘0’ in Table 5. In another embodiment, the BS may generate a resource allocation message defined in the IEEE 802.16 standard as shown in Table 8.

TABLE 8

| Syntax | Size | Notes |
|---|---|---|
| CID | 16 bits | |
| UIUC | 4 bits | |
| Duration | 10 bits | |
| Repetition | 2 bits | 0b00 No repetition coding |
| coding | | 0b01 Repetition coding of 2 used |
| indication | | 0b10 Repetition coding of 4 used |
| | | 0b11 Repetition coding of 6 used |

As shown in Table 8, the resource allocation message (UL_MAP_IE) includes: information about a connection ID (CID) identifying an MS to receive the resource allocation message; information about a UIUC indicating a physical channel processing scheme (e.g., a modulation scheme and a coding scheme) for a UL data burst to be transmitted; information about the duration indicating the size of a data burst in a UL burst through the resource allocation message; and information about a repetition coding indication indicating whether repetition coding has been performed on an information code of a data burst to be transmitted.

After generation of the resource allocation message in step 509 or 513, the BS transmits the generated resource allocation message to the mobile stations in step 511.

Thereafter, the operation is ended.

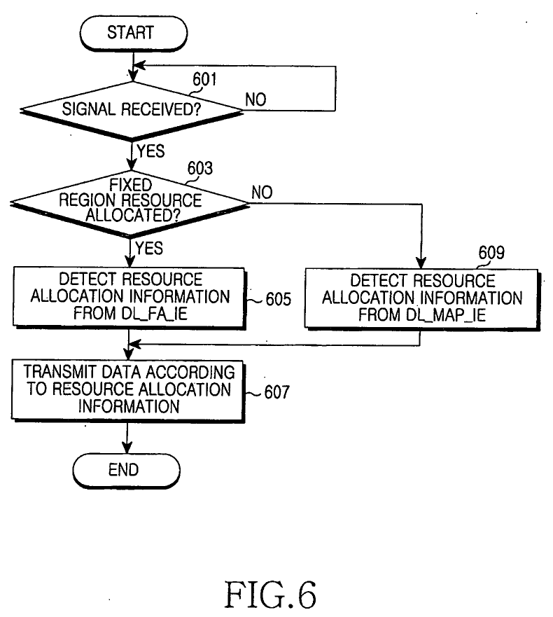

When the BS of the wireless communication system allocates radio resources as illustrated in FIG. 5, the MS operates as illustrated in FIG. 6 in order to detect the radio resources.

FIG. 6 is a flowchart illustrating an operation of the MS for transmitting UL signals in the wireless communication system according to an embodiment of the present invention.

Referring to FIG. 6, in step 601, the MS determines if a signal is received from the BS.

If a signal received from the BS, the operation proceeds to step 603. In step 603, the MS determines if the MS itself is allocated the fixed region resources, based on the resource allocation message included in the received signal. For example, the MS determines if the MS is allocated the fixed region resources, by detecting the fixed region allocation indicator in the resource allocation message constructed as shown in Table 5.

If the MS is allocated the fixed region resources, the operation proceeds to step 605. In step 605, the MS detects the fixed region resource allocation information from the resource allocation message constructed as shown in Table 5 or 6. For example, if the MS is initially allocated radio resources, the MS detects the fixed region resource allocation information from the resource allocation message constructed as shown in Table 5. At this point, the MS is allocated a fixed region ID through an initial resource allocation message constructed as shown in Table 5. Thus, if the MS is not initially allocated radio resources, the MS can detect the fixed region resource allocation information from the resource allocation message constructed as shown in Table 6. At this point, the MS can detect the start information of the fixed region and the allocated resource size information depending on the MCS level before receipt of the resource allocation message. Thus, the MS can detect the resources allocated to itself in the fixed region on the basis of the number of mobile stations having the same MCS level index as its own MCS level index shown in Table 6.

On the other hand, if the MS is not allocated the fixed region resources (in step 603), the operation proceeds to step 609. In step 609, the MS detects the resource allocation information from the resource allocation message constructed as shown in Table 5 or 8.

After detection of the resource allocation information, the MS transmits data to the BS according to the resource allocation information in step 607.

Thereafter, the operation is ended.

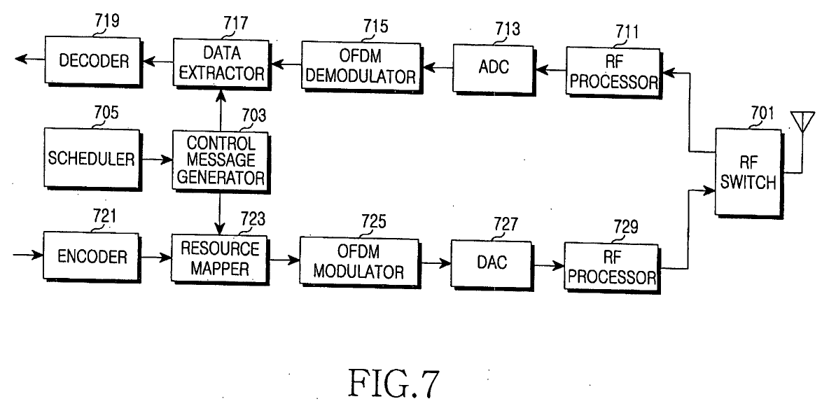

The BS, which allocates the fixed region resources to the mobile stations performing communication using fixed-length data in the wireless communication, is constructed as illustrated in FIG. 7.

FIG. 7 is a block diagram of the BS in the wireless communication system according to the present invention.

Referring to FIG. 7, the BS includes a radio frequency (RF) switch 701, a control message generator 703, a scheduler 705, an RF processor 711, an analog-to-digital converter (ADC) 713, an OFDM demodulator 715, a data extractor 717, a decoder 719, an encoder 721, a resource mapper 723, an OFDM modulator 725, a digital-to-analog converter (DAC) 727, and an RF processor 729.

The RF switch 701 switches a connection between an antennal and a transmit/receive (TX/RX) side. For example, the RF switch 701 switches the antenna to the RF processor 711 of the RX side in an RX period, and switches the antenna to the RF processor 729 of the TX side in a TX period.

The control message generator 703 generates a control message including resource allocation information of mobile stations to be provided with a service received from the scheduler 705. Herein, the control message generator 703 generates a DL MAP including resource allocation information of a DL region allocated to the mobile stations, and a UL MAP including resource allocation information of a UL region.

For example, if radio resources are initially allocated to mobile stations, the control message generator 703 constructs a DL MAP by generating resource allocation messages including radio resource allocation information for the respective mobile stations as shown in Table 1.

On the other hand, if radio resources are not initially allocated to mobile stations, the control message generator 703 constructs a DL MAP by generating a resource allocation message as shown in Table 1, 2 or 4, depending on the allocation or not of fixed region resources. That is, if fixed region resources are allocated to mobile stations, the control message generator 703 constructs a DL MAP by generating a resource allocation message including radio resource allocation information for the mobile stations as shown in Table 2. On the other hand, if fixed region resources are not allocated to mobile stations, the control message generator 703 constructs a DL MAP by generating resource allocation messages including radio resource allocation information for the respective mobile stations as shown in Table 1 or 4.

In another embodiment, if radio resources are initially allocated to mobile stations, the control message generator 703 constructs a UL MAP by generating resource allocation messages including radio resource allocation information for the respective mobile stations as shown in Table 5.

On the other hand, if radio resources are not initially allocated to mobile stations, the control message generator 703 constructs a UL MAP by generating a resource allocation message as shown in Table 5, 6 or 8, depending on the allocation or not of fixed region resources. That is, if fixed region resources are allocated to mobile stations, the control message generator 703 constructs a UL MAP by generating a resource allocation message including radio resource allocation information for the mobile stations as shown in Table 6. On the other hand, if fixed region resources are not allocated to mobile stations, the control message generator 703 constructs a UL MAP by generating resource allocation messages including radio resource allocation information for the respective mobile stations as shown in Table 5 or 8.

The scheduler 705 selects mobile stations to be provided with a service according to the channel states of the mobile stations, and allocates resources for the selected mobile stations. For example, if fixed region resources are allocated to the mobile stations, the scheduler 705 determines the resource size of a fixed region to be allocated to the MS, based on the MCS level of the mobile stations.

In the RX period, the RF processor 711 converts an RF signal received from the RF switch 701 into a baseband analog signal.

The ADC 713 converts the analog signal received from the RF processor 711 into a digital signal.

The OFDM demodulator 715 transforms a time-domain signal received from the ADC 713 into a frequency-domain signal by Fourier Transform. For example, the OFDM demodulator 715 transforms a time-domain signal into a frequency-domain signal by Fast Fourier Transform (FFT).

Based on the resource allocation information received from the control message generator 703, the data extractor 717 extracts data of subcarriers, which is to be actually received, from the frequency-domain signal received from the OFDM demodulator 715.

The decoder 719 demodulates/decodes the data received from the data extractor 717 in accordance with a predetermined modulation level (e.g., an MCS level), and provides the resulting data to an upper node.

In the TX period, the encoder 721 encodes/modulates the data received from the upper node in accordance with a predetermined modulation level (e.g., an MCS level).

Based on the resource allocation information received from the control message generator 703, the resource mapper 723 maps the data received from the encoder 721 to a corresponding subcarrier. At this point, the resource mapper 723 also maps the control message received from the control message generator 703 to the corresponding subcarrier.

The OFDM modulator 725 transforms the frequency-domain signal received from the resource mapper 723 into a time-domain signal by Inverse Fourier Transform. For example, the OFDM modulator 725 transforms a frequency-domain signal into a time-domain signal by Inverse Fast Fourier Transform (IFFT).

The DAC 727 converts the sample data received from the OFDM modulator 725 into an analog signal.

The RF processor 729 converts the analog signal received from the DAC 727 into an RF signal, and transmits the RF signal through the antenna according to the control of the RF switch 701.

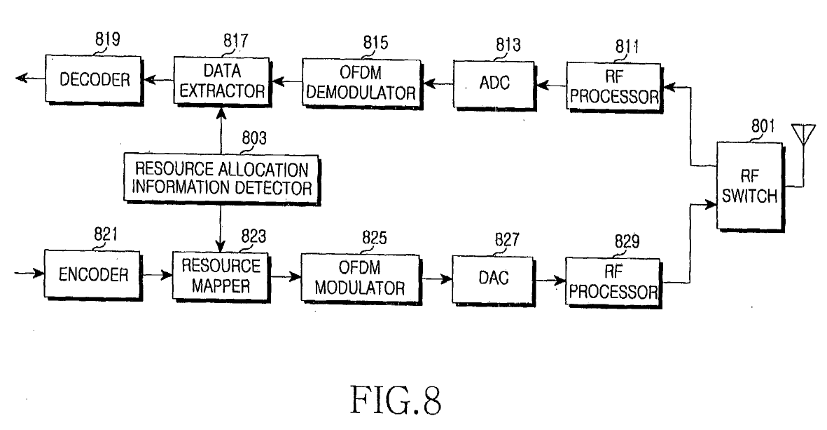

The MS to be allocated resources from the BS in the wireless communication system is constructed as illustrated in FIG. 8.

FIG. 8 is a block diagram of the MS in the wireless communication system according to the present invention.

Referring to FIG. 8, the MS includes an RF switch 801, a resource allocation information detector 803, an RF processor 811, an ADC 813, an OFDM demodulator 815, a data extractor 817, a decoder 819, an encoder 821, a resource mapper 823, an OFDM modulator 825, a DAC 827, and an RF processor 829.

The RF switch 801 switches a connection between an antennal and a transmit/receive (TX/RX) side. For example, the RF switch 801 switches the antenna to the RF processor 811 of the RX side in an RX period, and switches the antenna to the RF processor 829 of the TX side in a TX period.

In the RX period, the RF processor 811 converts an RF signal received through the antenna according to the control of the RF switch 801 into a baseband analog signal.

The ADC 813 converts the analog signal received from the RF processor 811 into a digital signal.

The OFDM demodulator 815 transforms a time-domain signal received from the ADC 813 into a frequency-domain signal by Fourier Transform. For example, the OFDM demodulator 815 transforms a time-domain signal into a frequency-domain signal by Fast Fourier Transform (FFT).

Based on resource allocation information received from the resource allocation information detector 803, the data extractor 817 extracts data of subcarriers, which is to be actually received, from the signal received from the OFDM demodulator 815 to output the extracted data to the decoder 819. Also, the data extractor 817 extracts control information from the signal received from the OFDM demodulator 815 to provide the extracted control information to the resource allocation information detector 803.

The decoder 819 demodulates/decodes the data received from the data extractor 817 in accordance with a predetermined modulation level (e.g., an MCS level), and provides the resulting data to an upper node.

The resource allocation information detector 803 detects DL/UL resources, which are allocated from the BS, from a resource allocation message included in the control information received from the data extractor 817. Thereafter, the resource allocation information detector 803 provides the resource allocation information to the data extractor 817 and the resource mapper 821.

In the TX period, the encoder 821 encodes/modulates the data received from the upper node in accordance with a predetermined modulation level (e.g., an MCS level).

Based on the resource allocation information received from the resource allocation information detector 803, the resource mapper 823 maps the data received from the encoder 821 to a corresponding subcarrier.

The OFDM modulator 825 transforms the frequency-domain signal received from the resource mapper 823 into a time-domain signal by Inverse Fourier Transform. For example, the OFDM modulator 825 transforms a frequency-domain signal into a time-domain signal by Inverse Fast Fourier Transform (IFFT).

The DAC 827 converts the sample data received from the OFDM modulator 825 into an analog signal.

The RF processor 829 converts the analog signal received from the DAC 827 into an RF signal, and transmits the RF signal through the antenna according to the control of the RF switch 801.

As described above, the wireless communication system allocates fixed region resources to the mobile stations performing communication using fixed-length data, and constructs a resource allocation message as shown in Table 2 or 6, thereby reducing the amount of resource allocation information. For example, in a case where DL resources are allocated to three mobile stations, if the BS constructs resource allocation messages for the mobile stations as shown in Table 4, up to 180-bit (3×60-bit) resources are required. However, in a case where fixed region resources are allocated to the mobile stations, if the BS constructs the resource allocation message for the mobile stations as shown in Table 2, 52-bit resources are required.

In another embodiment, in a case where UL resources are allocated to three mobile stations, if the BS constructs resource allocation messages for the mobile stations as shown in Table 8, up to 96-bit (3×32-bit) resources are required. However, in a case where fixed region resources are allocated to the mobile stations, if the BS constructs the resource allocation message for the mobile stations as shown in Table 6, 52-bit resources are required.

In accordance with the present invention as described above, a frame is constructed to include a fixed region to be allocated to mobile stations that periodically perform communication using data of the same size in the wireless communication system, thereby making it possible to reduce the amount of resource allocation information for the MS and thus increase the efficiency of DL resources.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for allocating resources in a wireless communication system, the method comprising:
determining whether there are one or more mobile stations periodically transmitting or receiving data of the same size, among mobile station to be provided with a service, if a predetermined region of a frame is set as a fixed region to be allocated to mobile stations that periodically transmit or receive data of the same size;
detecting the channel states of the mobile stations if there are mobile stations periodically transmitting or receiving data of the same size;
allocating resources of the fixed region according to the channel states of the mobile stations; and
transmitting the resource allocation information to the mobile stations.

2. The method of claim 1, further comprising transmitting information of the fixed region to mobile stations within a coverage area if the predetermined region of the frame is set as the fixed region.

3. The method of claim 2, wherein the fixed region information comprises at least one of information about the start point of the fixed region in the frame and information about the size of the resource to be allocated according to the channel states of the mobile stations.

4. The method of claim 3, wherein the information about the size of the resource to be allocated according to the channel state indicates the number of slots to be allocated to the mobile station according to a Modulation and Coding Scheme (MCS) level of the mobile station.

5. The method of claim 2, wherein the transmitting of the fixed region information comprises:
generating an Uplink Channel Description (UCD) message or a Downlink Channel Description (DCD) message including the fixed region information; and
transmitting the generated message to the mobile stations.

6. The method of claim 1, wherein the allocating of the resources comprises:
detecting the MCS level according to the channel state of the mobile station;
classifying the mobile stations as mobile stations having the same MCS level; and
allocating resources of a fixed region for each of the mobile stations according to the MCS level for each of the classified mobile stations.

7. The method of claim 1, wherein the transmitting of the resource allocation information comprises:
determining whether there is a mobile station to be initially allocated radio resources, among the mobile stations;
if there is a mobile station to be initially allocated radio resources, generating a message including resource information of a fixed region to be allocated to the mobile station; and
transmitting the generated message to the mobile station.

8. The method of claim 7, wherein the message comprises at least one of indicator information indicating the allocation or not of the resources of the fixed region, identifier information of a mobile station allocated resources in the fixed region, usage period information of resources allocated in the fixed region, usage count information of resources allocated in the fixed region, and size information of a resource region allocated in the fixed region.

9. The method of claim 7, wherein the generating of the message comprises, if there are one or more mobile stations to be initially allocated the radio resources, generating one or more messages each including resource allocation information of a fixed region for each of the mobile stations.

10. The method of claim 7, further comprising:
if there are one or more mobile stations not to be initially allocated the radio resources, generating a message including resource information of a fixed region allocated to the mobile stations; and
transmitting the generated message to the mobile stations.

11. The method of claim 10, wherein the message comprises at least one of information about the MCS levels of mobile stations to be allocated the resources of the fixed region, information about the number of mobile stations having the same MCS level, and information about identifiers of mobile stations allocated the fixed region resources.

12. A method for detecting allocated resources in a wireless communication system, the method comprising:
if a predetermined region of a frame is set as a fixed region to be allocated to mobile stations that periodically transmit or receive data of the same size; obtaining information of the fixed region from a transmitter; and
detecting resources of the fixed region, allocated from the transmitter, from resource allocation information received from the transmitter, if data of the same size are transmitted or received periodically.

13. The method of claim 12, wherein the fixed region information comprises at least one of information about the start point of the fixed region in the frame and information about the size of the resource to be allocated according to the channel states of the mobile stations.

14. The method of claim 13, wherein the information about the size of the resource to be allocated according to the channel state indicates the number of slots to be allocated to the mobile station according to a Modulation and Coding Scheme (MCS) level of the mobile station.

15. The method of claim 12, wherein the fixed region information is received through an Uplink Channel Description (UCD) message or a Downlink Channel Description (DCD) message.

16. The method of claim 12, wherein the detecting of the fixed region resources comprises detecting, if radio resources are initially allocated, at least one of identifier information of a mobile station allocated resources in the fixed region from the radio allocation information, usage period information of resources allocated in the fixed region, usage count information of resources allocated in the fixed region, and size information of a resource region allocated-in the fixed region.

17. The method of claim 12, wherein the detecting of the fixed region resources comprises:
detecting, if radio resources are not initially allocated, the number and order of mobile stations having the same MCS level information from the radio allocation information; and
detecting a resource region allocated from the transmitter according to the fixed region information in consideration of the number and order of mobile stations having the same MCS level information.

18. An apparatus for allocating resources in a wireless communication system, the apparatus comprising:
a scheduler for allocating, when a predetermined region of a frame is set as a fixed region to be allocated to mobile stations that periodically transmits or receives data of the same size, resources of the fixed region to the mobile station that periodically transmits or receives data of the same size;
a message generator for generating a message including information of the fixed region and generating a resource allocation message for the mobile station allocated to the fixed region by the scheduler; and
a transmitter for transmitting the resource allocation message to the mobile stations.

19. The apparatus of claim 18, wherein the scheduler detects MCS levels according to the channel states of mobile stations periodically transmitting or receiving data of the same size, to allocate resources of a fixed region according to the respective MCS levels for the respective mobile stations having the same MCS level.

20. The apparatus of claim 18, wherein the message includes at least one of information about the start point of the fixed region in the frame and information about the size of the resource to be allocated according to the channel states of the mobile stations.

21. The apparatus of claim 20, wherein the information about the size of the resource to be allocated according to the channel state indicates the number of slots to be allocated to the mobile station according to a Modulation and Coding Scheme (MCS) level of the mobile station.

22. The apparatus of claim 18, wherein the message generator generates an Uplink Channel Description (UCD) message or a Downlink Channel Description (DCD) message including the fixed region information.

23. The apparatus of claim 18, wherein the message generator generates, if there is a mobile station to be initially allocated the radio resources, the resource allocation message including at least one of indicator information indicating the allocation or not of the resources of the fixed region, identifier information of a mobile station allocated resources in the fixed region, usage period information of resources allocated in the fixed region, usage count information of resources allocated in the fixed region, and size information of a resource region allocated in the fixed region.

24. The apparatus of claim 23, wherein the message generator generates, if there are one or more mobile stations to be initially allocated the radio resources, the resource allocation messages for the respective mobile stations.

25. The apparatus of claim 18, wherein the message generator generates, if there is no mobile station to be initially allocated the radio resources, the resource allocation message including at least one of information about the MCS levels of mobile stations to be allocated the resources of the fixed region, information about the number of mobile stations having the same MCS level, and information about identifiers of mobile stations allocated the fixed region resources.
